(19) United States
(12) Patent Application Publication
(10) Pub. No.: US 2025/0003285 A1
(43) Pub. Date: Jan. 2, 2025

(54) Improved Sliding Door

(71) Applicant: CAVITY SLIDERS LIMITED, Auckland (NZ)

(72) Inventors: Christopher Matthew Spiller, Auckland (NZ); Philip Richard Kenny, Auckland (NZ)

(21) Appl. No.: 18/696,443

(22) PCT Filed: Sep. 29, 2022
(86) PCT No.: PCT/IB2022/059267

§ 371 Date: Mar. 28, 2024

(30) Foreign Application Priority Data
Sep. 30, 2021 (NZ) 780768

(51) Int. Cl. E06B 3/46; E05D 15/06; E05F 15/635; E06B 1/52

(52) U.S. Cl. CPC E06B 3/4654; E05D 15/0617; E05D 15/063; E05D 15/0665; E05F 15/635; E06B 1/52; E05Y 2201/64; E05Y 2201/684; E05Y 2900/14

(57) ABSTRACT

An improved sliding door assembly is provided to be installed adjacent to a doorway having a split jamb. The door leaf is supported on a door carrier that extends between a top edge and a bottom edge of a frame, while the frame has at least one track configured to guide the door carrier and a rotatable tie rod mounted to the door carrier extending 5 between the top edge and the bottom edge of the frame and having a pinion gear at each end to engage with a rack at the top edge and bottom edge respectively such that engagement of the pinion gears synchronises the motion of the door carrier.

### FIELD OF THE INVENTION

The present invention relates to sliding doors. More particularly, but not exclusively, it relates to a pocket sliding door assembly for providing an improved sliding door with a concealed track.

### BACKGROUND OF THE INVENTION

Pocket sliding doors, also known as cavity sliding doors, are a space efficient alternative to hinged doors or other sliding door types. In a pocket sliding door installation, the door leaf slides horizontally in the doorway and retracts into a pocket concealed in an adjacent wall. Generally, the doorway has tracks in the floor and/or the head jamb that extend into the pocket and facilitate sliding of the door leaf. The resulting assembly allows for a door that is fully concealed within the wall when open, taking up no space within a room.

However, the typical pocket sliding door has a number of shortcomings. Because much of the appeal of pocket sliding doors is their sleek, concealed appearance, having the track and rollers visible is generally considered undesirable. To achieve this sleek appearance, a floor track is typically omitted and the overhead track and rollers are preferably concealed for example by fascia at the top edge of the doorway. Pocket sliding doors sometimes require maintenance however, requiring the fascia to be removed in order to access the track and/or remove the door leaf. This means that there are often fasteners visible in the doorway, which may have to be painted over to reduce their visual impact. Maintenance and subsequent reassembly can be a complicated process, as the fascia may be damaged during removal and the door leaf can be difficult to disengage especially if a rear roller carriage is concealed inside the pocket. Special tools may be required to access the necessary parts of the roller carriages.

It is thus desirable to find alternative pocket sliding door solutions that maintain the sleek appearance of having no visible mechanisms, but that minimise the additional work needed to install, replace or perform maintenance on the pocket sliding door.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

For the purpose of this specification, where method steps are described in sequence, the sequence does not necessarily mean that the steps are to be chronologically ordered in that sequence, unless there is no other logical manner of interpreting the sequence.

It is an object of the present invention to provide an improved sliding door which overcomes or at least partially ameliorates some of the abovementioned disadvantages or which at least provides the public with a useful choice.

### BRIEF DESCRIPTION OF THE INVENTION

According to a first aspect the invention broadly comprises a pocket sliding door assembly comprising:
a pocket frame configured to be installed adjacent to a doorway and having a split jamb;
a door carrier extending substantially between a top edge and a bottom edge of the pocket frame;
at least one track contained within the pocket frame and configured to guide the door carrier;
a rotatable tie rod mounted to the door carrier on an inner side and extending substantially between the top edge and the bottom edge of the pocket frame, the tie rod having a pinion gear at each end configured to engage with a corresponding horizontal length of rack teeth at the top edge and the bottom edge;
wherein engagement of the pinion gears synchronises the motion of the door carrier.

According to another aspect, there are no tracks running beyond the split jamb of the pocket frame.

According to another aspect, an outer side of the door carrier is configured to attach to a door leaf.

According to another aspect, the door carrier is configured to cantilever the door leaf from within the pocket frame.

According to another aspect, engagement of the pinion gears keeps the door carrier vertically aligned during motion, thereby preventing in-plane tilting of the door leaf.

According to another aspect, the door leaf is disengageable from the door carrier.

According to another aspect, the door leaf is engaged at a rear edge.

According to another aspect, the door leaf can be engaged or disengaged without the use of tools.

According to another aspect, the outer side of the door carrier presents at least one attachment point configured to engage with at least one door hook of the door leaf.

According to another aspect, the door leaf is kept engaged by gravity and can be disengaged by lifting the hooks out of the attachment points.

According to another aspect, the pocket sliding door assembly is installed adjacent a doorway having an overhead element.

According to another aspect, the doorway is defined by the split jamb, the overhead element and a closing element that is a closing jamb or a wall.

According to another aspect, a substantially identical pocket sliding door assembly is installed adjacent an opposite edge of the doorway and facing inwardly to create a double closing sliding door.

According to another aspect, the overhead element of the doorway is a flush ceiling.

According to another aspect, the overhead element of the doorway is a head jamb.

According to another aspect, the clearance between the top of the door leaf and the overhead element is between 5 mm and 20 mm.

According to another aspect, the clearance between the top of the door leaf and the overhead element is between 5 mm and 10 mm.

According to another aspect, the at least one track is a bottom track only.

According to another aspect, the at least one track is a bottom track and a top track.

According to another aspect, further comprising a groove in the at least one track.

According to another aspect, the door carrier comprises a bottom wheel and/or a top wheel configured to run in the groove of the at least one track.

According to another aspect, the pocket sliding door assembly further comprises one or more guide wheels attached to the ends of the tie rod and adjacent the pinion gears, the one or more guide wheels configured to run in the groove of the at least one track.

According to another aspect, the door leaf has a door groove in a top edge and/or a bottom edge configured to engage with the front end stop to align the door leaf.

According to another aspect, the rack teeth are presented by a rack mounted on the at least one track.

According to another aspect, the at least one track is formed integrally with the rack teeth.

According to another aspect, the pinion gears and the rack teeth are helical.

According to another aspect, the pocket sliding door assembly further comprises a motor configured to drive the tie rod thereby moving the door carrier.

According to another aspect, further comprising a controller connected to the motor and to one or more sensors, wherein the controller is configured to allow for the automation of the pocket sliding door assembly.

According to another aspect the invention broadly comprises a system to improve guidance of a sliding door leaf in a doorway comprising:
a channel extending along a length of a top edge of the door leaf;
a plunger embedded in an overhead element that partially defines the doorway;
at least one magnet fixed to the channel and/or the plunger;
wherein the at least one magnet is configured to move the plunger vertically from a retracted condition to an extended condition engaged with the channel when the channel is in close proximity,
wherein engagement of the plunger and the channel provides guidance to the door leaf as it slides,
wherein the plunger is biased by a biasing mechanism to move from the extended condition to the retracted condition when the channel is no longer in close proximity.

According to another aspect, the channel extends along a partial length of the top edge of the door leaf;

According to another aspect, the plunger has one of the at least one magnets fixed to it.

According to another aspect, the channel comprises a plate made from a ferromagnetic material.

According to another aspect, one of the at least one magnets is fixed in the channel.

According to another aspect, an end of the plunger incorporates a ferromagnetic material.

According to another aspect, the at least one magnet is a rare earth magnet.

According to another aspect, the clearance between the top of the door leaf and the overhead element is between 5 mm and 30 mm.

According to another aspect, the clearance between the top of the door leaf and the overhead element is between 5 mm and 20 mm.

According to another aspect, the clearance between the top of the door leaf and the overhead element is between 5 mm and 10 mm.

According to another aspect, the plunger is in the form of an inverted ‘T’.

According to another aspect, the system is used with a sliding door that rolls in a track at a bottom edge of the doorway.

According to another aspect, the system is used with the pocket sliding door assembly of any of the previous sliding door assembly clauses.

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification and claims means “consisting at least in part of”. When interpreting statements in this specification and claims which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 shows a perspective view of a doorway with a cutaway wall to show a door pocket.

FIG. 2 shows a lower perspective view of a doorway with a trackless sliding door.

FIG. 3A shows a side view of the sliding door assembly.

FIG. 3B shows a side view of the sliding door assembly with the slats removed.

FIG. 3C shows a side view of the sliding door assembly with the slats and posts removed.

FIG. 3D shows a side view of the sliding door assembly with the slats, posts and door leaf removed.

FIG. 4 shows a perspective view of the top track.

FIG. 5 shows a perspective view of the bottom track.

FIG. 6 shows a side cross-sectional view of the sliding door assembly.

FIG. 7 shows a perspective view of the bottom pinion gear and guide wheel.

FIG. 8 shows a perspective cross-sectional view of the door carrier bottom wheel.

FIG. 9A shows a side cross-sectional view of an attachment point and an engaged door hook.

FIG. 9B shows a perspective view of an attachment point and an engaged door hook, with the door carrier not shown.

FIG. 10 shows a perspective view of the top track and door groove.

FIG. 11 shows a lower perspective view of a doorway with a sliding door and the additional guidance system.

FIG. 12A shows a lower perspective view of the plunger in the retracted condition.

FIG. 12B shows a lower perspective view of the plunger in the extended condition.

FIG. 13A shows a perspective view of the additional guidance system with the plunger in the retracted condition and the mounting arrangement hidden.

FIG. 13B shows a perspective view of the additional guidance system with the plunger in the extended condition and the mounting arrangement hidden.

FIG. 14A shows a perspective cross-sectional view of the additional guidance system with the plunger in the retracted condition.

FIG. 14B shows a perspective cross-sectional view of the additional guidance system with the plunger in the extended condition.

### DETAILED DESCRIPTION OF PREFERRED EMBODIMENTS

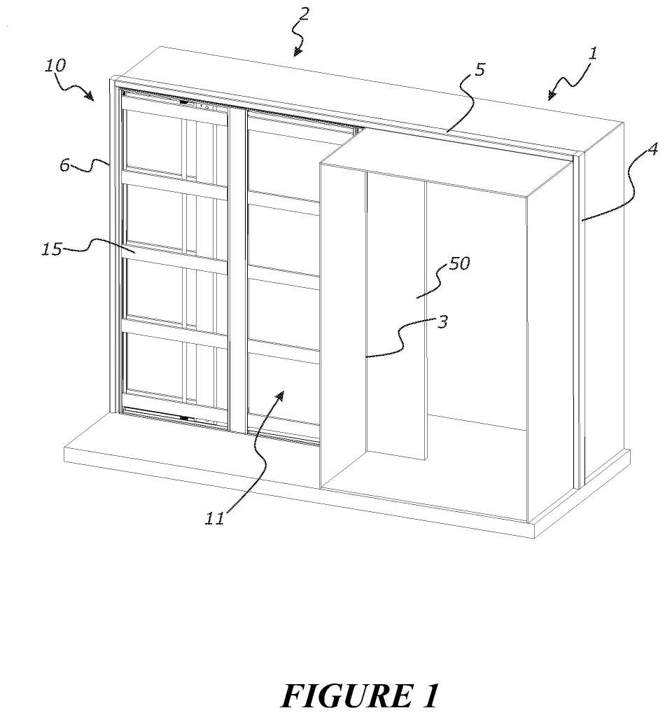

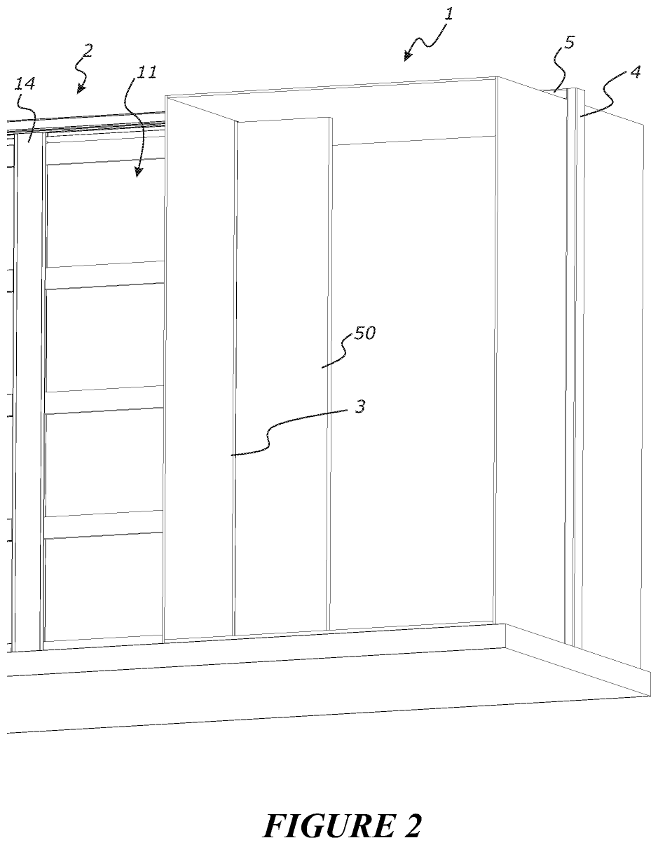

The present invention is a trackless sliding door as provided by a pocket sliding door assembly 10. A sliding door is defined to mean a door that opens and closes by moving horizontally in its own plane. Sliding may encompass any such horizontal translation, for example as supported by wheels or other rollers. A trackless sliding door is defined to mean that there are no tracks present in the doorway as depicted in FIGS. 1 and 2, i.e. there are no tracks running beyond the split jamb across the top or bottom edges of the doorway. It does not mean that the assembly does not utilise tracks for sliding, only that they are not present in the doorway itself and are thus fully concealed from view.

According to various aspects of the various embodiments of the present invention as illustrated in FIGS. 1-9, there is provided an apparatus for a trackless sliding door which will now be described.

The present invention resides in a sliding door assembly 10 for installation in a wall 7 adjacent a doorway 1. The sliding door assembly 10 provides a pocket frame 11 within the wall 7 into which a door leaf 50 can retract. During construction the doorway 1 may be defined by a split jamb 3 which is the opening to the pocket frame 11 and a closing jamb 4 opposite the split jamb 3.

A head jamb 5 may extend across the top edge of the doorway 1, and potentially further across the top of the pocket frame 11 to a rear stud 6.

The overhead element of the doorway 1 may be a flush ceiling, i.e. the top of the doorway 1 is at ceiling height. In this case the head jamb 5 is above and fully concealed by the ceiling finishing, or the structure of the doorway 1 is such that a head jamb 5 is not required.

Alternatively, the top of the doorway 1 and hence the head jamb 5 may be below ceiling height, and may be at least partially concealed by wall finishings and/or fascia. The closing element of the doorway 1 may be a wall, in which case the closing jamb 4 may be concealed behind the wall by wall finishings or the door leaf 50 may close directly against the wall without there being any closing jamb 4.

FIG. 1 shows how the head jamb 5 may be concealed above the ceiling height, while the pocket door assembly 10 and the closing jamb 4 may be concealed in opposite walls. FIG. 2 shows the clean and seamless appearance of a trackless sliding door with a flush ceiling from within the doorway 1, where the ceiling is flat and continuous above the door leaf 50 with only minimal clearance.

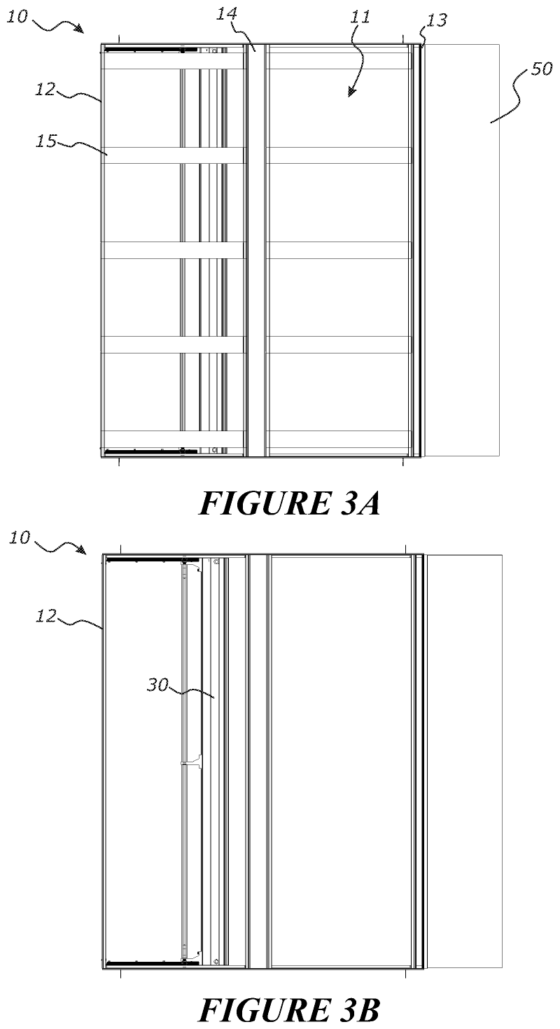

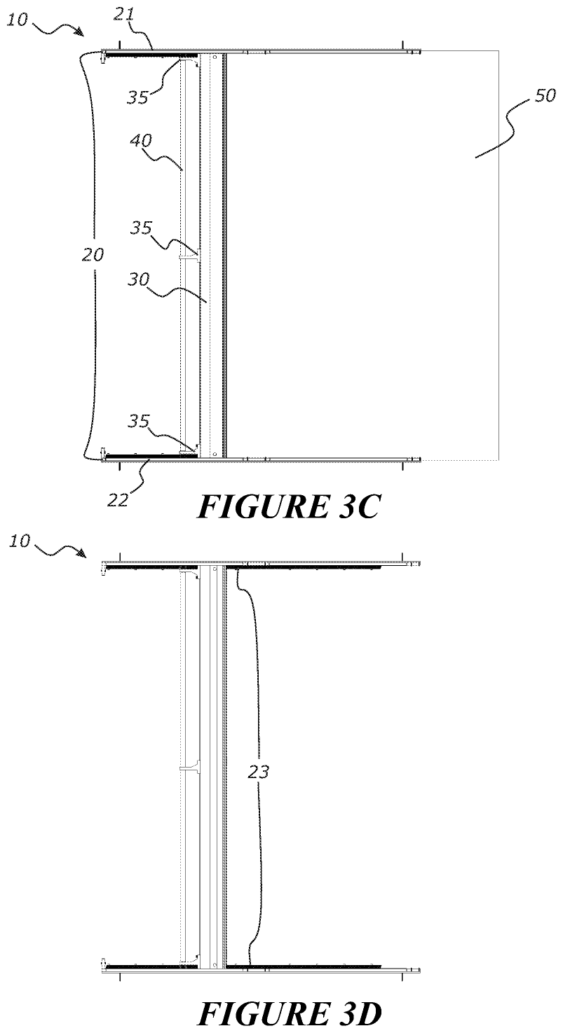

As shown in FIGS. 3A-3D, the pocket sliding door assembly 10 comprises the pocket frame 11, at least one track 20, a slidable door carrier 30 and a rotatable tie rod 40 mounted to the door carrier 30. The door leaf 50 may be attached to the door carrier 30. The tracks 20 are preferably a top track 21 and a bottom track 22 running across top and bottom edges of the pocket frame 11 respectively. The slidable door carrier 30 extends between the top and bottom edges of the pocket frame 11 and is configured to slide on the at least one track 20.

The door carrier 30 has an outer side 32 which the door leaf 50 attaches to at a rear edge, and an inner side 31 on which the rotatable tie rod 40 is mounted for example using brackets 35. The rotatable tie rod 40 extends between the top and bottom edges of the pocket frame 11, parallel to the door carrier 30, and has pinion gears 41 at each end that each engage with horizontal lengths of rack teeth 23. The engagement of the pinion gears 41 prevents tilting of the door leaf 50, as the rotatable tie rod 40 synchronises the movement between the top and bottom edges of the door carrier 30 and hence of the door leaf 50.

This rotatable tie rod 40 prevents what would otherwise be a significant problem resulting from the door carrier 30 cantilevering the door leaf 50. Because the door leaf 50 has significant weight, tilting would occur within the plane of the door leaf 50 such that the front bottom corner would drop relative to the rear bottom corner. The top of the door carrier 30 would be pulled forward relative to the bottom. Because the clearance between the bottom edge of the door leaf 50 and the floor is small, such tilting could cause the front bottom corner to hit the ground and prevent sliding. Furthermore, vertical misalignment of the door carrier 30 resulting from tilting could cause it to bind in the tracks 20 and interrupt sliding. The rotatable tie rod 40 preferably keeps the door carrier 30 vertically aligned with the top and bottom motion synchronised, making the sliding action smoother and preventing binding.

As shown in FIGS. 3A-3B, the pocket frame 11 may comprise structural elements such as a back post 12 that extends between and connects the tracks 20 at a back end, front posts 13 that extend between and connect the tracks 20 at a front end while leaving a gap for the door leaf 50, and central posts 14 that extend between and connect the centre of tracks 20. These posts preferably provide pocket frame 11 with a rigid structure in combination with horizontal structural elements at the top and bottom, which are preferably the tracks 20. The front posts 13 preferably form the split jamb 3 which is to define part of the doorway 1 when the pocket sliding door assembly 10 is installed. The structural elements of the pocket frame 11 are preferably made from metal, for example aluminium or steel, and bolted together.

Horizontal slats 15 may extend between the posts and partially form sides of the pocket frame 11, further reinforcing the stiffness of the pocket frame 11. The slats 15 are configured such that they do not interfere with the motion of the door carrier 30 or the door leaf 50, but to some extend they may act as guides. As such there may be only a minimal clearance between for example the slats 15 and the side faces of the door leaf 50. The slats may be made of wood, a wood-plastic composite, or any other suitable material, and may rest in a slot rather than being fastened into place.

A pocket sliding door assembly 10 is preferably configured to be shipped and installed as a complete unit that acts as an installable pocket frame 11, and may or may not include the door leaf 50. The door carrier 30 is preferably preinstalled within the pocket frame 11 and can remain inside during the installation process. During installation, the top track 21 may be fastened to the head jamb 5 or another overhead member, the bottom track 22 may be fastened to the section of floor upon which the pocket frame 11 sits, and the back post 12 may be fastened to the rear stud 6. Wall linings can then be applied to conceal the pocket frame 11 within the wall, and the door leaf 50 can be attached to the door carrier 30.

Alternatively, the pocket sliding door assembly 10 may be configured to be shipped and installed in some other configuration, for example as separate components requiring assembly, or with the door carrier 30 not preinstalled, or with components of the doorway 1 such as the head jamb 5 preattached.

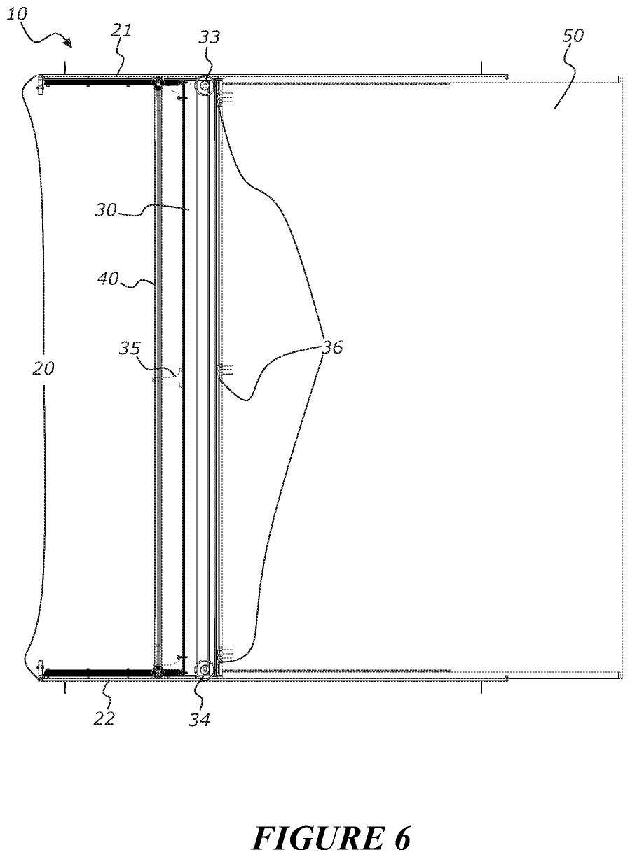

The door carrier 30 presents one or more attachment points 36 on an outer side 32 for the door leaf 50 to attach to. These attachment points 36 may be spaced evenly along the outer side 32. As shown in FIG. 6, there may be three attachment points 36 spaced evenly at the top, bottom and centre of the outer side 32.

To simplify the process of removing the door leaf 50 from the doorway 1, for example to facilitate maintenance, the door leaf 50 is preferably disengageable from the door carrier 30. The door leaf 50 may therefore present a plurality of vertically aligned door hooks 51 at a rear edge, which can each then be hooked into a recess of an attachment point 36. The hooked connection is maintained by gravity, so to disengage the door leaf 50 it can be lifted slightly such that the door hooks 51 come free from the attachment points 36. When the pocket sliding door assembly 10 is installed in a doorway 1, the door leaf 50 may be disengaged and removed by first closing it, then lifting it, and then angling it to carry it out from the doorway 1. Alternatively, it may be easier to have the door leaf 50 at least partially open to disengage it, for example so that the front bottom corner can be used as a pivot.

The door leaf 50 can also be engaged with the door carrier 50 by lifting it back into place such that the door hooks 51 engage with the attachment points 36 once more. This simplifies initial setup of the sliding door and makes it easier to replace the door leaf 50 if necessary.

The ability to engage or disengage the door leaf 50 with a simple lifting action solves a problem typically experienced by pocket sliding doors. Typical methods of concealing tracks and roller mechanisms inherently make the door leaf 50 difficult to install and remove, because those tracks and mechanisms engage with the top or bottom edge of the door leaf 50 and must later be accessed for disengagement. Options for simplifying disengagement are limited because of the need to be ‘invisible’ and visually unobtrusive. Engagement at a rear edge of the door leaf 50 is a fundamentally different approach which allows all tracks and mechanisms to be fully concealed from view within the pocket frame 11. Additionally, there are preferably no tools required to engage or disengage the door leaf 50, because one or more persons may be able to provide the necessary lifting force.

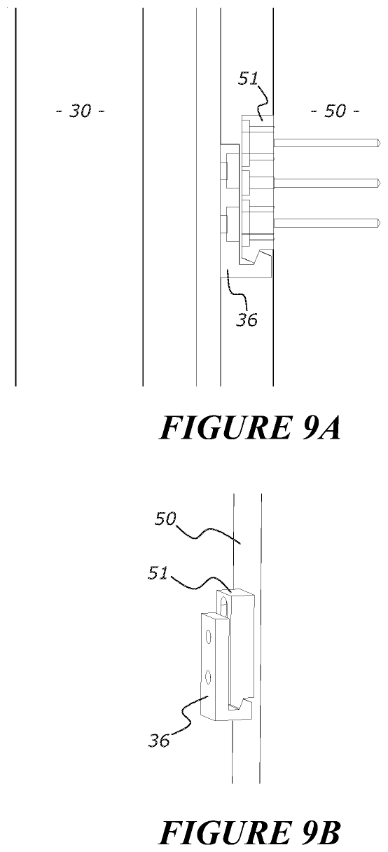

As shown by the cross-section of FIG. 9A, attachment points 36 may be attached to the outer side 32 of the door carrier 30 by fasteners such as bolts. Likewise, the door hooks 51 may be attached to the edge of the door leaf 50 by fasteners such as screws. The contact surfaces of the attachment points 36 and the door hooks 51 may be angled slightly such that it is easier to engage and disengage the door hooks 51 compared to strictly vertical engagement. The angled surfaces may also facilitate disengagement of the door hooks 51 with a combination of pulling and lifting forces or by tilting, and may also minimise the vertical displacement necessary for disengagement.

The connection of the attachment points 36 and the door hooks 51 preferably creates a flush connection surface between the outer side 32 of the door carrier 30 and the edge of the door leaf 50. The friction at this connection surface facilitates a strong and rigid connection between the door carrier 30 and the door leaf 50. To achieve this, the attachment points 36 may be inset into the outer side 32 of the door carrier 30. FIG. 9B shows a perspective view of an attachment point 36 connected to a door hook 51, omitting the door carrier 30 for clarity.

In order for the door hooks 51 to be vertically engaged and disengaged from the attachment points 36, there must be a clearance between the top of the door leaf 50 and the overhead element of the doorway 1 (i.e. the ceiling or the head jamb 5). Typical pocket sliding door arrangements may also require such a clearance, but overhead attachment may require a clearance sufficiently large that it must be concealed by fascia to avoid an obvious gap being visible above the door. The rear edge attachment method of the pocket sliding door assembly 10 allows for a clearance sufficiently small to be visually unobtrusive, not requiring additional steps for concealment. For example, the connection between attachment points 36 and door hooks 51 may be configured such that the clearance required for engagement and disengagement is between 5 mm and 30 mm. Preferably the required clearance is between 5 mm and 20 mm. More preferably still the required clearance is be between 5 mm and 10 mm. In one preferred embodiment the required clearance is approximately 8 mm.

It will be appreciated that other engagement configurations are possible, but preferably all involve primarily rear edge engagement of the door leaf 50 with the door carrier 30 so as to retain the above-mentioned benefits. There may be some degree of engagement with the side faces of the door leaf 50, but in order to be visually unobtrusive this would have to be to only a minor extent such that it is either not obvious or concealed from view within the pocket frame 11 when the door is fully closed. For example, the outer side 32 of the door carrier 30 could present a channel that wraps around the rear edge of the door leaf 50 to make contact with its side faces. Preferably this channel would be only as deep as necessary to prevent lateral movement. Engagement would still be primarily at the rear edge, for example a single attachment point 36 could be used with a single door hook 51 to support the vertical load and provide in-plane horizontal support force.

In other embodiments, there could be any number of attachment points 36 formed in a suitable way for example as slots, holes or similar. The rear edge of the door leaf 50 may then present corresponding formations suitable for engagement.

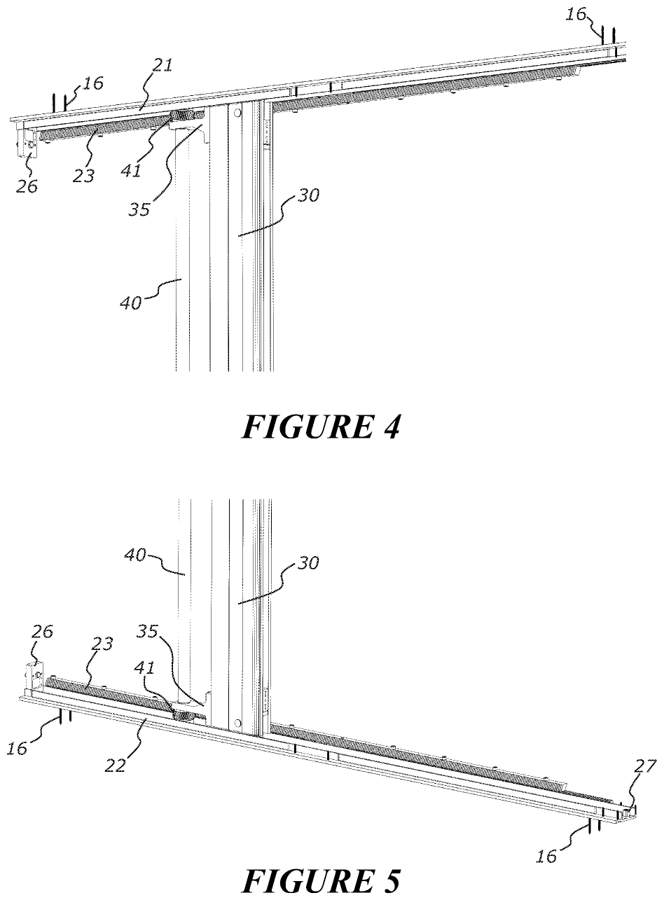

As shown in FIGS. 4 and 5, the top track 21 and bottom track 22 have substantially the same features. Rack teeth 23 extend along most of the length of each track 20, mounted on one side with the teeth facing inwardly. Preferably the rack teeth 23 are of the helical type, i.e. angled teeth, such that they are configured to engage with a helical pinion gear 41.

The track 20 may have a central groove 24 running its length, which may have a raised notch 25 in the centre. The groove 24 and/or the raised notch 25 may help to locate the door carrier 30 and the door leaf 50 as they move in the pocket frame 11, facilitating smooth and linear sliding motion. The rack teeth 23 may then run along an outer edge of the groove 24, facing inwardly towards the centre of the groove 24.

It will be appreciated that the rack teeth 23 may be formed as a discrete rack that is mounted to the track 20 and/or fixed framing with fasteners, or alternatively may be formed integrally with the track 20. In an alternative embodiment, there may be no upper track 21 such that only a rack presenting rack teeth 23 extends along the top edge of the pocket frame 11. The door carrier 30 is thus configured to slide primarily by rolling in the bottom track 22, but may have guide wheels configured to engage for example with the rack on the opposite side to the rack teeth 23.

As shown in FIGS. 4 and 5, the track 20 comprises a rear end stop 26 at a back end and a front end stop 27 at a front end, which limit the motion of the door carrier 30 at each extreme of the pocket frame 11. The rear end stop 26 may have a cutout to accommodate a pinion gear 41 and/or a bracket 35, as it will be the bracket 35 or the tie rod 40 that physically contacts the rear end stop 26.

The front end stop 26 may be mounted on top of the raised notch 25 and is preferably configured to be easily removable from the track 20 when the door leaf 50 is removed. Once the front end stop 26 is removed from each track 20, the door carrier 30 can then be pulled out from the pocket frame 11 to facilitate maintenance. As such, the front end stop 27 may be threaded such that it can be unscrewed from the track 20 by turning it, or it may otherwise slot or clip in to the track 20 in an easily removable manner.

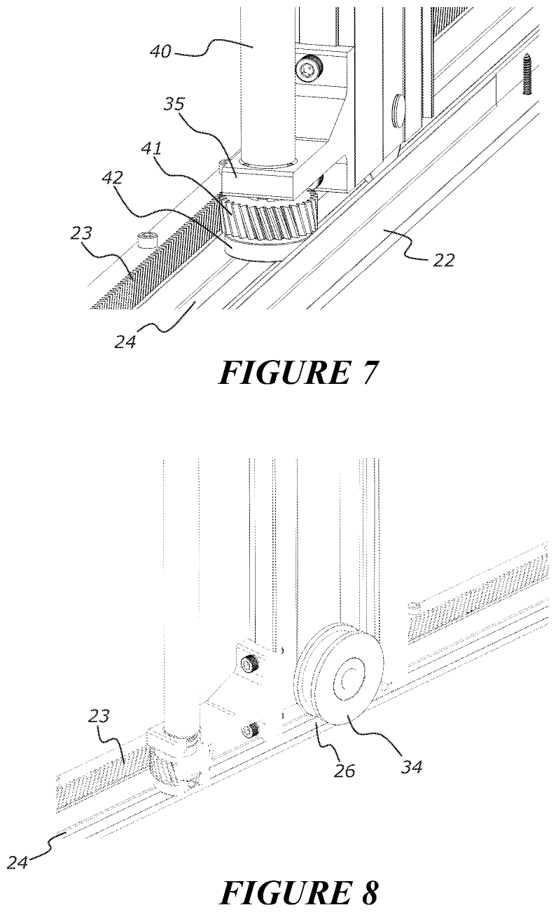

As shown in FIG. 7, the rotatable tie rod 40 may additionally comprise a guide wheel 42 adjacent the pinion gear 41. The guide wheel 42 sits within the groove 24 of the track 20 and serves to prevent undesirable lateral movement of the tie rod 40 and/or door carrier 30, thereby facilitating smooth and linear sliding motion. FIG. 7 depicts a guide wheel 42 running in the bottom track 22, but a guide wheel 42 can be provided for running in the top track 21 in the same manner.

As shown in FIG. 6, the door carrier 30 has a top wheel 33 and a bottom wheel 34 that run in the tracks 20. These wheels may be the primary load-bearing sliding elements that facilitate smooth and linear sliding motion of the door. The bottom wheel 34 may support most of the weight of the door leaf 50. As shown in FIG. 8, the bottom wheel 34 may sit within the groove 24 of the bottom track 22. The wheel may have split rims that run on either side of the raised notch 25, helping to locate the wheel and keep it running smoothly along the track 20 without lateral movement. The top wheel 33 may run in the groove 24 of the top track 21 in the same manner.

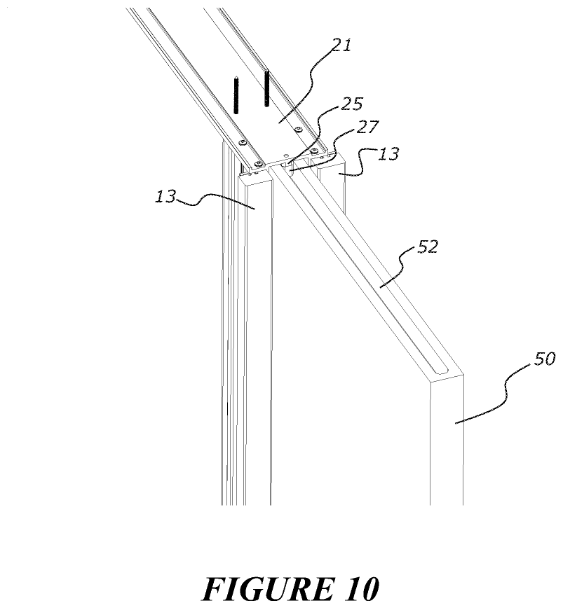

As shown in FIG. 10, the door leaf 50 may have a door groove 52 in an edge. This may receive the raised notch 25 and/or the front end stop 27 when the door leaf 50 is retracted into the pocket frame 11, assisting in locating the door leaf 50 and preventing lateral motion. FIG. 10 shows a door groove 52 in the top edge of the door, but a door groove 52 could equally be provided in the bottom edge.

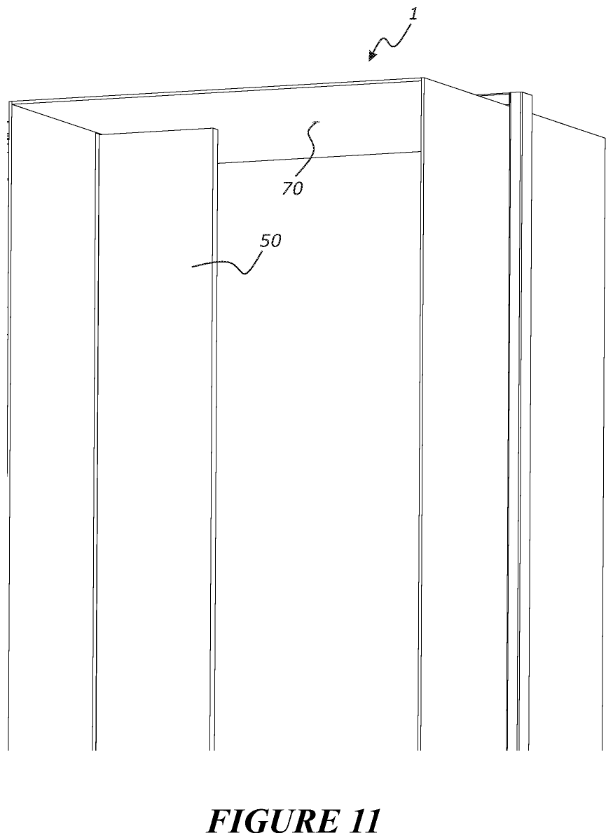

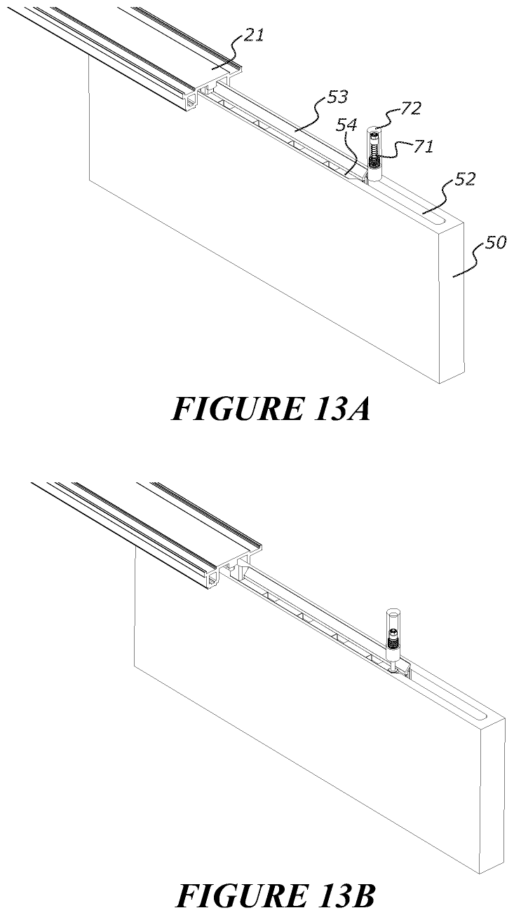

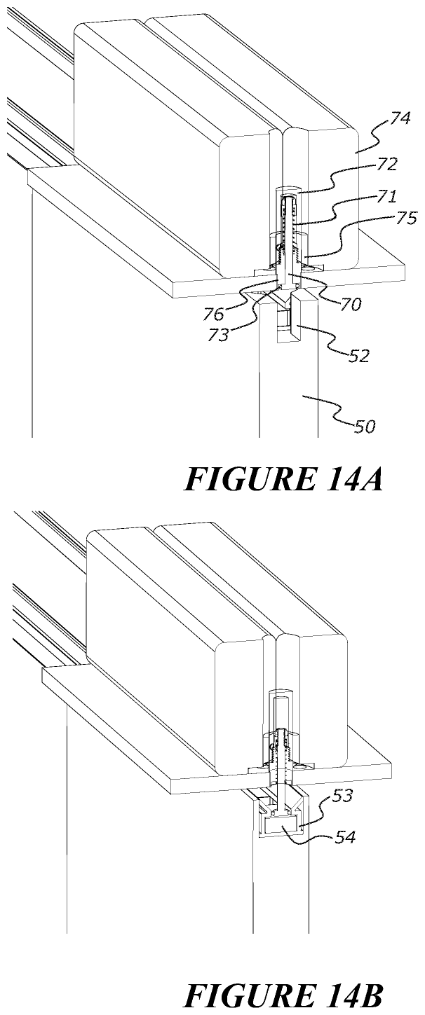

In one embodiment as shown in FIG. 11, the trackless sliding door includes an additional guidance system to improve guidance of the door leaf 50 in the doorway 1. As shown in FIGS. 13A-13B and 14B, a length of the top edge of the door leaf 50 incorporates a channel 53 which is preferably contained within the door groove 52. This is preferably a partial length of the top edge. An overhead element defining the top of the doorway 1, i.e. the head jamb 5 or the ceiling, has a plunger 70 embedded into it within a mounting hole, and the plunger 70 can move by magnetic attraction between a retracted condition as shown in FIG. 11A and an extended condition as shown in FIG. 11B in which it provides guidance to the door leaf 50.

The plunger 70 is magnetically attracted to the channel 53 and drops down into the extended condition when the channel 53 is in close proximity, which will occur when the door leaf 50 extends sufficiently far out from the pocket. In the extended condition the plunger 70 engages with the channel 53 and remains engaged as the door leaf 50 slides. In the extended condition the plunger 70 may act to guide the door leaf 50 by supporting some of the cantilevered loading and/or by preventing lateral movement of the door leaf 50. The plunger 70 is biased into the retracted condition by a biasing mechanism 71, preferably a spring. Thus, it retracts again as soon as the channel 53 is no longer in close proximity to the plunger 70, which will occur when the door leaf 50 moves back inside the pocket.

The plunger 70 preferably extends from a housing 72 situated above the mounting hole 76 and hence concealed from view above or inside the overhead element. The housing 72 may be fixed in place by a mounting bracket 75, which may be fixed to the overhead element or some other concealed mounting element 74 by fasteners such as screws. A cutout may be provided in the overhead element or other mounting element 74 in order to accommodate the housing 72 and the mounting bracket 75. The mounting element 74 may be a beam-type mounting element, and it may comprise two such beams sandwiched together around the housing 72 and the mounting bracket 75.

The housing contains a biasing mechanism 71 which biases the plunger 70 into the retracted condition, which is preferably a spring configured to become compressed when the plunger 70 is pulled down through the mounting hole 76 into the extended condition.

To facilitate magnetic attraction between the plunger 70 and the channel 53, at least one magnet 54 is located in the channel 53 and/or at the end of the plunger 70. The at least one magnet 54 must be strong enough to overcome the force of the biasing mechanism 71 and may be a rare earth magnet to provide sufficient strength. The channel 53 or the end of the plunger 70 may be made of or incorporate a ferromagnetic material, for example steel, which the magnet 54 will be attracted to. Many magnet configurations are possible, but the polarity of the magnets 54 must be configured such that whenever the plunger 70 and the channel 53 are in close proximity they will be attracted together rather than repulsed.

In one embodiment, the end of the plunger 70 incorporates a magnet 54 and the channel 53 incorporates a ferromagnetic plate that the magnet 54 will be sufficiently attracted to such that the plunger 70 will move into the extended condition when in close proximity to the channel 53. The attraction is also sufficient to keep the plunger 70 engaged with the channel 53 during sliding of the door. This embodiment may be suitable when the clearance between the overhead element and the door leaf 50 is especially small.

In a further embodiment where additional magnetic strength is needed to move the plunger 70 into the extended condition, for example when the clearance between the overhead element and the door leaf 50 is larger, a secondary magnet 54 to facilitate attraction may be fitted in the channel 53 at the leading end. The polarities of the magnets 54 are configured to attract the plunger 70 and the channel 53 together. Once engaged, the ferromagnetic plate is preferably then sufficient to keep the plunger 70 and the channel 53 engaged during sliding of the door without assistance from the secondary magnet 54.

In an alternative embodiment as shown in FIGS. 13A-13B and 14B, the end of the plunger 70 is ferromagnetic and the channel 53 has multiple magnets 54 spaced along its length. Spacing may be configured as appropriate to maintain the correct polarity of the magnets 54 and to ensure the attraction is sufficient to move the plunger 70 into the extended condition and keep the plunger 70 engaged with the channel 53 during sliding of the door.

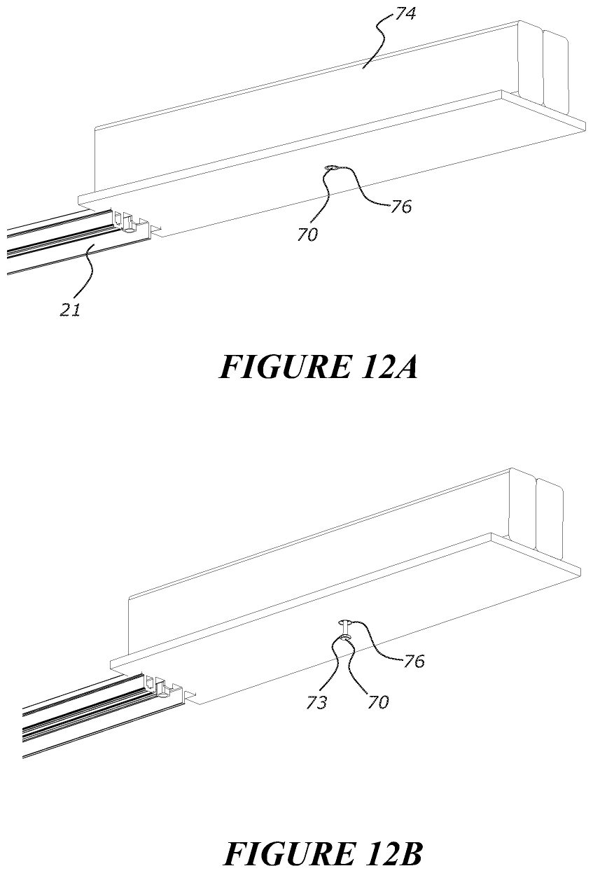

As shown in FIG. 12, the channel 53 may extend only a partial length of the top edge of door leaf 50, while the door groove 52 may extend a greater length and hence have sections extending further from either end of the channel 53. The section of the door groove 52 that accommodates the channel 53 is preferably widened in comparison to the other sections. The placement of the channel 53 may be roughly central on the door leaf 50, or it may be towards the closing edge of the door leaf 50, or alternatively it could be in some other suitable location on the door leaf 50.

The length of the channel 53 must be at least the length of extension of the door which is to receive guidance from the guidance system. For example, if the final 200 mm of door extension is to receive guidance from the guidance system, the channel must be at least 200 mm long. The location of the plunger 70 in the overhead element is then selected based on the placement of the channel 53 in order to achieve the desired guidance extent. For example, if a 200 mm long channel 53 is set in the door leaf 50, the door groove 52 extends an additional 150 mm towards the front side of the door leaf 50, and the door is to receive guidance along its final 200 mm of extension, the plunger 70 may be set inwardly from the top corner of the closing side of the doorway 1 by around 350 mm in order to achieve the desired 200 mm guidance extent. Preferably the guidance system is configured to provide guidance over at least the final 100 mm of door extension. Alternatively, it may be configured to provide guidance over at least the final 200 mm of door extension.

Engagement between the end of the plunger 70 and the channel 53 may be at least partially indirect, i.e. there may be an air gap between the magnetically coupled elements to minimise friction. There may be an annular O-ring 73 around the end of the plunger 70, which may at least intermittently contact the sides of channel 53 and transmit forces that assist in preventing lateral movement. The magnetic connection may be configured to oppose lateral movement in addition to providing the vertical attraction force. The channel 53 may slope inwardly at the top of each side in order to help guide the plunger 70 into engagement when moving into the extended condition.

The additional guidance system is preferably configured to be as visually unobtrusive as possible to retain the benefits of a trackless sliding door. The end of the plunger 70 in the retracted condition is preferably configured to be roughly flush with the overhead element such that the plunger 70 is not easily visible. The O-ring 73 may seal any gap between the end of the plunger 70 and the mounting hole in the overhead element, which may also contribute to a flush appearance. When the plunger 70 is pulled into the extended condition by the channel 53 it is preferably mostly concealed from view within the door groove 52, with the amount that is visible dependent on the clearance between the top edge of the door leaf 50 and the overhead element. In alternative configurations, plunger 70, may have an inverted ‘T’ shape as shown in FIG. 12B. Alternatively still, such an inverted ‘T’ shape may interact with channel 53, to become captured.

For purposes of visual concealment of the plunger 70 and for aiding in magnetic attraction between the plunger 70 and the channel 53, the clearance between the top edge of the door leaf 50 and the overhead element is preferably minimal. Minimised clearance may be facilitated by the rear edge door attachment of pocket door assembly 10 as previously described. For example, the clearance may between 5 mm and 30 mm which may be suitable for embodiments with multiple magnets 54. Or more preferably the clearance may be between 5 mm and 20 mm, which may further be suitable for embodiments with a single magnet 54. More preferably still the clearance may be between 5 mm and 10 mm. In a preferred embodiment the clearance may be approximately 8 mm.

It will be appreciated that the guidance system described above may be used with many other types of sliding door arrangements. It is ideally suited to cantilevered sliding doors supported from within the pocket, but it could also be used for example with sliding doors having a track along the bottom of the doorway 1 which supports the door through rollers.

The guidance system may be especially useful in conjunction with sliding door arrangements where the final length of door extension is prone to misalignment that may cause binding or other issues. For example, it may be useful in conjunction with an especially heavy door leaf 50 that is prone to tilting as it extends further from the pocket. The guidance system may also be useful with doors having a latch at the closing edge of the door leaf 50, requiring precise alignment upon closing in order to engage, and/or with double closing sliding doors where it is desirable for the abutting closing edges of each door leaf 50 to align laterally.

Prevention of out-of-plane tilting and lateral misalignment of the door carrier 30 and door leaf 50 may be a combined effect of the pinion gears 41, guide wheels 42, top wheel 33, bottom wheel 34, door groove 52, front posts 13, split jamb 3 and optionally the additional guidance system. Prevention of in-plane tilting and vertical misalignment of the door carrier 30 is primarily achieved by the tie rod 40 and its pinion gears 41 engaging with the rack teeth 23.

Adjustment mechanisms may be provided for various components in order to calibrate alignment during installation or maintenance. For example, an adjustment mechanism may allow the position of one set of rack teeth 23 to be adjusted relative to the other, or for one of the pinion gears 41 to be rotated relative to the other. For example, at least one rack may be bolted in place (or otherwise moveably fixed), so that positional adjustments can be made.

Alternatively, at least one pinion gear 41, may be fixed on its shaft via one or more grub screws, such that position adjustments can be made.

Alternatively, there may be no adjustment mechanisms provided and all alignment of components within the pocket sliding door assembly 10 may be performed during initial assembly and prior to installation. The installer of the pocket sliding door assembly 10 may then align it adjacent the doorway 1 using conventional construction tools and techniques. This may be ideal when the pocket sliding door assembly 10 is manufactured offsite with high precision and shipped as an installable unit.

The rotatable tie rod 40 may be mounted on the inner side 31 of the door carrier 30 by a plurality of brackets 35. One or more of the brackets 35 may contain a bearing, for example a radial ball or roller bearing, to facilitate smooth rotation of the tie rod 40. These bearings may be configured to resist axial forces that may be generated by the pinion gears 41 during movement. The brackets 35 may be spaced evenly along the inner side 31. As shown in FIGS. 3A-3D and FIG. 6 there may be brackets 35 supporting the tie rod 40 at its ends and at its centre. Preferably the end brackets 35 contain radial ball bearings, and the central bracket may contain a bush bearing to ensure concentricity.

The brackets 35 create a distance between the door carrier 30 and the tie rod 40. This distance may be beneficial in providing leverage for the guide wheels 42 and/or pinion gears 41 mounted on the tie rod 40, as the door carrier 30 may act as a pivot point for lateral movement of the door leaf 50 and a longer lever arm between the tie rod 40 and the door carrier 30 may increase the effect of the guide wheels 42 and/or pinion gears 41 in preventing such lateral movement.

Helical teeth are preferred for pinion gears 41 and rack teeth 23 for their benefits of quiet operation, smoother motion and greater tooth strength. However straight-cut teeth may also be used and may have some benefit in slightly reduced cost. The material used for the pinion gears 41 and rack teeth 23 may be a metal or alternatively a polymer such as nylon.

To keep the pinion gears 41 in synchronisation and hence prevent the tilting of the door leaf 50, torsional deflection of the tie rod 40 must be minimised. Thus, tie rod 40 is preferably made from a material with a high torsional stiffness, for example aluminium or steel, and/or it may have a geometry that allows sufficient stiffness. A thin-walled tube may be used to reduce the amount of material required and hence reduce the cost of the component while still achieving the necessary torsional stiffness.

In an alternative embodiment, the pocket sliding door assembly 10 may further comprise an electric motor 60 configured to drive the rotatable tie rod 40. This thereby drives the pinion gears 41 and moves the door carrier 30 along the tracks 20. The engagement of the pinion gears 41 with the rack teeth 23 means that only one motor 60 is required to drive the top and bottom edges of the door carrier 30 in synchronisation. Because the motor 60 would have to be mounted to the moving door carrier 30, electric power may be supplied to the motor 60 via a length of cable having enough slack to allow for the door carrier 30 to move along the full extent of the tracks 20. Strain relief systems as known in the art may also be used with the cable.

Alternatively, metallic elements of the pocket sliding door assembly 10 may act as conductors to transmit power to the motor 60. For example, some part of one or both of the tracks 20 may act as conductors, and may transmit electrical power to the door carrier 30 via the pinion gears 41, the guide wheels 42, or some other conductive component configured to receive electrical power.

A pocket sliding door assembly 10 having an electric motor 60 may be configured as an automated sliding door. Thus, the motor 60 may be connected to a controller 61 configured to provide a control signal. The controller may be further connected to one or more sensors 62. The controller 61 and the sensors 62 may be part of the pocket sliding door assembly 10 or they may be external to it. The sensors 62 may include motion sensors for detecting a person moving close to the doorway 1, buttons or touchpads adjacent the doorway 1, or limit sensors configured to detect when the door carrier 30 or door leaf 50 has reached a desired location. The sensors 62 may be simple switches or they may be electronic sensors that provide an output signal, for example passive or active infrared sensors.

The controller 61 and the sensors 62 are configured such that when some input signal is provided, the sliding door is opened automatically. The sliding door may then be closed automatically after a fixed time period, or in response to a second input signal. For example, a person may press a button causing the door to open automatically, then a second press of the same button or another button may cause the door to close automatically. Alternatively, the controller 61 may be connected to a home automation system, such that a person can remotely open or close the sliding door, and/or the controller may be configurable to change the behaviour of the sliding door.

In a further alternative embodiment, two pocket sliding door assemblies 10 could be installed on opposite sides of a doorway 1 such that a double closing sliding door is created. In this case there would be no closing jamb 4 as such because the doors would meet in the middle, rather each side of the doorway 1 would have a split jamb 3 and the doors would retract in opposite directions. A user may be able to open the doorway 1 by moving the doors separately or by moving both doors simultaneously.

In one embodiment of a double closing sliding door, each pocket sliding door assembly 10 may have an electric motor 60 as described above. Furthermore the double closing sliding door may be automated as described above such that it has a controller 61 configured to control both doors. The controller 61 may also facilitate partial automation wherein sensors 62 can detect a user manually moving one door and the controller 61 drives the other door to move in synchronisation.

A double closing sliding door may be synchronised using electronic means as described above, but alternatively it may be synchronised mechanically, for example by a cable mechanism concealed above the doorway 1.

It will be appreciated that the pocket sliding door assembly 10 and the trackless sliding door it provides for represent a departure from the conventional practices of suspending the door leaf 50 from a track that runs across the head jamb 5 and/or running the door leaf 50 in a floor track within the doorway 1. Instead the door leaf 50 is cantilevered by a door carrier 30 concealed fully within the pocket frame 11 and running on tracks 20 that are also concealed within the pocket frame 11 and do not extend past the split jamb 3. This allows for a number of advantages over conventional pocket sliding door systems.

Firstly, a sleek trackless appearance is created wherein there are no tracks or mechanisms that can be seen from the doorway 1. Only the door leaf 50 is visible and it moves smoothly back and forth from the split jamb 3 without any other component being revealed.

Secondly, fascia or panels fitted around the head jamb 5 are not required to conceal the track that would otherwise be present. This allows for use with a flush ceiling, or if fascia is to be used around a head jamb 5 then there is no need for it to be easily removable and have visible fasteners.

Thirdly, because the door leaf 50 can be engaged and disengaged from the door carrier 30 by lifting of the door leaf 50 without any need for tools, maintenance is greatly simplified. Once the door leaf 50 is free from the attachment points 36, it can be angled slightly to remove it from the doorway 1. The front end stops 27 can then be removed so that the door carrier 30 can be pulled off the tracks 20 if maintenance is required. Because of the trackless configuration, this process does not require any removal of fascia or other panels from the doorway 1 before the door leaf 50 can be removed.

The primary challenge of realising the above benefits by cantilevering the door leaf 50 from inside the pocket is in preventing tilting of the door carrier 30 and door leaf 50 that would cause jamming. Being contained within a wall 2 of a building, space in the pocket is limited and extending it backward to accommodate a large support structure in addition to the door leaf 50 would be overly costly and impractical. However, the use of the rotatable tie rod 40 and the other mechanisms as previously described represent an efficient solution to this problem that does not greatly increase the necessary size of the pocket.

To those skilled in the art to which the invention relates, many changes in construction and widely differing embodiments and applications of the invention will suggest themselves without departing from the scope of the invention as defined in the appended claims.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

1. A pocket sliding door assembly comprising:
a pocket frame configured to be installed adjacent to a doorway and having a split jamb;
a door carrier extending substantially between a top edge and a bottom edge of the pocket frame;
at least one track contained within the pocket frame and configured to guide the door carrier;
a rotatable tie rod mounted to the door carrier on an inner side and extending substantially between the top edge and the bottom edge of the pocket frame, the tie rod having a pinion gear at each end configured to engage with a corresponding horizontal length of rack teeth at the top edge and the bottom edge respectively;
wherein engagement of the pinion gears synchronises the motion of the door carrier.

2. The pocket sliding door assembly of claim 1, wherein there are no tracks running beyond the split jamb of the pocket frame.

3. The pocket sliding door assembly of claim 1, wherein an outer side of the door carrier is configured to attach to a door leaf.

4. The pocket sliding door assembly of claim 3, wherein the door carrier is configured to cantilever the door leaf from within the pocket frame.

5. The pocket sliding door assembly of claim 4, wherein engagement of the pinion gears keeps the door carrier vertically aligned during motion, thereby preventing in-plane tilting of the door leaf.

6. The pocket sliding door assembly of claim 3, wherein the door leaf is disengageable from the door carrier, at a rear edge of said door leaf.

7. (canceled)

8. The pocket sliding door assembly of claim 6, wherein the door leaf can be engaged or disengaged without the use of tools, and wherein the door leaf is kept engaged by gravity and can be disengaged by lifting the hooks out of the attachment points.

9. The pocket sliding door assembly of claim 8, wherein the outer side of the door carrier presents at least one attachment point configured to engage with at least one door hook of the door leaf.

10. (canceled)

11. The pocket sliding door assembly of claim 3, wherein the pocket sliding door assembly is installed adjacent a doorway having an overhead element, and wherein the doorway is defined by the split jamb, the overhead element and a closing element that is a closing jamb or a wall.

12. (canceled)

13. The pocket sliding door assembly of claim 11, wherein a substantially identical pocket sliding door assembly is installed adjacent an opposite edge of the doorway and facing inwardly to create a double closing sliding door.

14. The pocket sliding door assembly of claim 11, wherein the overhead element of the doorway is a flush ceiling.

15. The pocket sliding door assembly of claim 11, wherein the overhead element of the doorway is a head jamb.

16. The pocket sliding door assembly of claim 11, wherein the clearance between the top of the door leaf and the overhead element is:
a) between 5 mm and 30 mm, or
b) between 5 mm and 20 mm, or
c) between 5 mm and 10 mm.

17.-18. (canceled)

19. The pocket sliding door assembly of claim 1, wherein the at least one track is a bottom track only.

20. The pocket sliding door assembly of claim 1, wherein the at least one track is a bottom track and a top track.

21. The pocket sliding door assembly of claim 1, further comprising a groove in the at least one track, and wherein the door carrier comprises a bottom wheel and/or a top wheel configured to run in the groove of the at least one track.

22. (canceled)

23. The pocket sliding door assembly of claim 21, further comprising one or more guide wheels attached to the ends of the tie rod and adjacent the pinion gears, the one or more guide wheels configured to run in the groove of the at least one track.

24. The pocket sliding door assembly of claim 1, wherein the at least one track has a front end stop configured to be removable to facilitate pulling the door carrier out from the pocket frame for maintenance, and wherein the door leaf has a door groove in a top edge and/or a bottom edge configured to engage with the front end stop to align the door leaf.

25.-28. (canceled)

29. The pocket sliding door assembly of claim 1, further comprising a motor configured to drive the tie rod thereby moving the door carrier, and a controller connected to the motor and to one or more sensors, wherein the controller is configured to allow for the automation of the pocket sliding door assembly.

30. (canceled)

31. A system to improve guidance of a sliding door leaf in a doorway comprising:
a channel extending along a length of a top edge of the door leaf;
a plunger embedded in an overhead element that partially defines the doorway;
at least one magnet fixed to the channel and/or the plunger;
wherein the at least one magnet is configured to move the plunger vertically from a retracted condition to an extended condition engaged with the channel when the channel is in close proximity,
wherein engagement of the plunger and the channel provides guidance to the door leaf as it slides,
wherein the plunger is biased by a biasing mechanism to move from the extended condition to the retracted condition when the channel is no longer in close proximity.

32.-44. (canceled)
